(19) United States
(12) Patent Application Publication
(10) Pub. No.: US 2019/0139521 A1
(43) Pub. Date: May 9, 2019

(54) Tuning Ring for Adjusting Sound Timbre of Drum Head

(71) Applicant: HPI (Tianjin) Musical Instrument Co., Ltd., Tianjin City (CN)

(72) Inventor: Aijun Lu, Tianjin City (CN)

(73) Assignee: HPI (Tianjin) Musical Instrument Co., Ltd.

(21) Appl. No.: 15/804,709

(22) Filed: Nov. 6, 2017

(51) Int. Cl. G10D 13/02

(52) U.S. Cl. CPC G10D 13/023; G10D 13/021

(57) ABSTRACT

A tuning ring for adjusting a sound timbre of a drum head includes: a tuning ring body for disposing beneath a bottom surface of the striking portion of the drum head and having an opening so as to reduce the unstable sound timbre and the uncertain fluttering overtone, thereby causing the tuned sound timbre clear and being concentrated to be a thicker sound timbre and optimizing the sound timbre of the drum head. If the present invention is applied to the drum head which has been stretched to a finished state, the tuned sound timbre does not change, thereby achieving the abovementioned optimal quality of the tuned sound timbre.

### BACKGROUND OF THE INVENTION

### 1. Field of the Invention

The present invention generally relates to a tuning device for a percussion instrument, and more particular to a tuning ring for adjusting a sound timbre of a drum head (of a drum).

### 2. The Prior Arts

A drum is one type of percussion instrument and generally includes a drum shell of cylindrical shape, a drum head mounted on one or both ends of the drum shell and a hoop or rim sleeved around the drum head for fixing the drum head relative to the drum shell. The drum head is generally made from animal leathers and/or rubber membranes.

The drum head made from animal leather generally generates more complex resonance sound, such as relatively heavy and high density sound feeling and its high bass sound can be controlled easily. However, the manufacturing process for animal leathers is relatively complicated and hence results in high expense in addition to causing pollution to the environment so that obtaining the animal leather is not easy. Moreover, the animal leathers can absorb moisture easily, the sound quality and its high bass sound are extremely unstable.

The rubber film or membrane for fabrication of the drum head is obtainable easily at a low cost, is waterproof and has many other advantages, thereby improving the manufacturing process for the drum heads. FIG. 1 shows a graph illustrating a test waveform generated due to beating of a conventional drum head, wherein the overall waveform is more complex, uncertainty of the pitch overtone, and the length of the entire waveform is longer, which means that the sound is more unstable, more uncertain in the fluttering process and the ending sound seems longer. In the case of continuous beating of the drum head, the latter may generate more overtones and overlapping sound, the sound thickness and concentration of the feeling is significantly weak. In other words, the drum head made from plastic film produces sound thickness and density is insufficient, the sound flutters, and is weak in cohesion and degree of saturation.

### SUMMARY OF THE INVENTION

A primary objective of the present invention is to provide a tuning ring for adjusting a sound timbre of a drum head so as to reduce the uncertainty of pitch overtone, and the duration of the waveform being shorter so as to demonstrate the sound timbre to be clear and is concentrated to be a thicker sound timbre, thereby optimizing quality of the tuned sound timbre generated from the drum head.

Another objective of the present invention is to provide a tuning ring for adjusting a sound timbre of a drum head and if the present invention is applied to the drum head, which has been stretched to a finished state, the tuned sound timbre does not change, and achieving the abovementioned optimal quality of the tuned sound timbre.

In order to achieve the abovementioned objectives, the tuning ring of the present invention for adjusting a sound timbre of a drum head, includes a tuning ring body adapted to be provided beneath a bottom surface of the striking portion of a drum head and the tuning ring body has an opening.

In one embodiment of the present invention, the tuning ring body defines an axis coaxial with the opening and further has a surface area equivalent to 20-40% surface area of the striking portion of the drum head.

Preferably, the tuning ring body has a surface area equivalent to 25-35% surface area of the striking portion of the drum head.

Preferably, the tuning ring body is cylindrical, polygonal or irregular in configuration.

Preferably, the tuning ring body has a top end formed with an adhesive layer via which the tuning ring body is attached adhesively to the bottom surface of the striking portion of the drum head.

Preferably, the adhesive layer has a thickness of 0.01-0.05 mm.

In one embodiment of the present invention, the tuning ring body has a thickness less than 1 mm.

In one embodiment of the present invention, the drum shell has a top part and a peripheral portion confining the bottom surface of the striking portion of the drum head for abutting against the top part of the drum shell, the drum shell further has an inner peripheral portion confining the top part and is spaced apart from an outer peripheral portion of the tuning ring body by a distance of 10-40 mm.

Preferably, the tuning ring body is fabricated from plastic film and/or membrane or paper.

Preferably, the tuning ring of the present invention includes several units of the tuning ring bodies for disposing beneath the bottom surface of the striking portion of the drum head in an overlapping manner.

One distinct feature of the present invention resides in that since the tuning ring of the present invention is disposed at a position, where the drum stick cannot directly hit on the same, but the tuning ring can adjust the sound timbre of a drum head, the overall thickness of the tuning ring combined with the drum head, thereby changing the original sound timbre of the drum head and reducing the unstable sound timbre, the uncertainty of pitch overtone, shortening the duration of the waveform, and hence the sound timbre is clear and is concentrated to be a thicker sound timbre and optimizing the sound timbre of the drum head. If the present invention is applied to the drum head, which has been stretched to a finished state, the tuned sound timbre does not change, and achieving the abovementioned optimal quality of the tuned sound timbre.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a graph illustrating a test waveform generated due to beating of a conventional drum head;

FIG. 2 is a perspective view of a drum, which is constituted by a drum shell, a drum head, a hoop and a tuning ring of the present invention;

FIG. 3 is an exploded and perspective view of the drum together with the tuning ring of the present invention;

FIG. 4 is a top view of the drum together with the tuning ring of the present invention;

FIG. 5 is a cross sectional view of the drum together with the tuning ring of the present invention;

FIG. 6 is a fragmentary cross sectional view of the drum together with the tuning ring of the present invention;

FIG. 7 shows a drum head beating test device for conducting test adjustment of a sound timbre of a conventional drum head and a drum head provided with the tuning ring of the present invention;

FIG. 8 shows a graph illustrating a test waveform generated due to beating of a drum head provided with the tuning ring of the present invention; and

FIG. 9 shows a graph illustrating two test waveforms generated due to beating of a conventional drum head and a drum head provided with the tuning ring of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

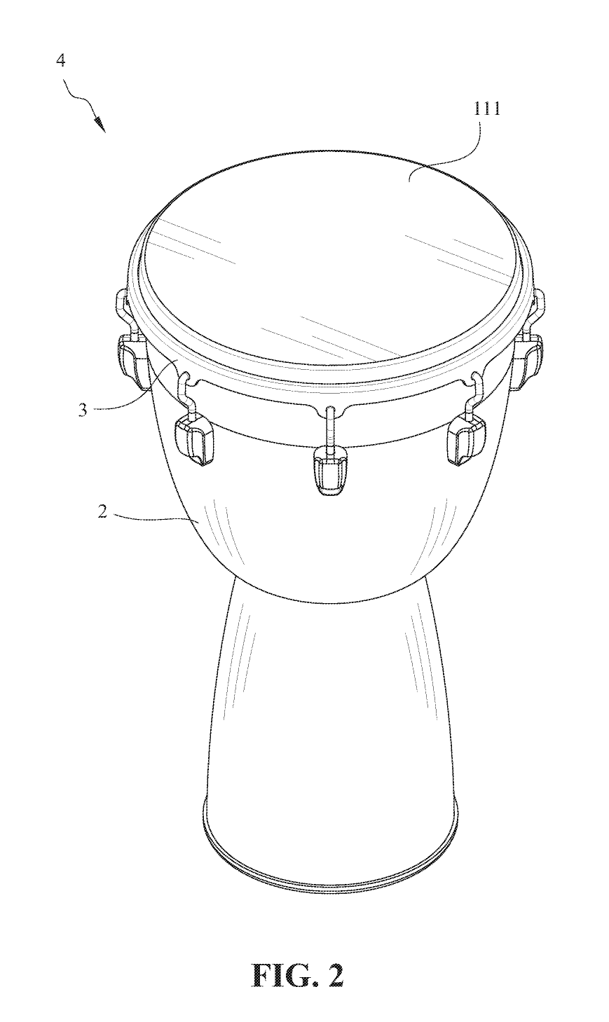

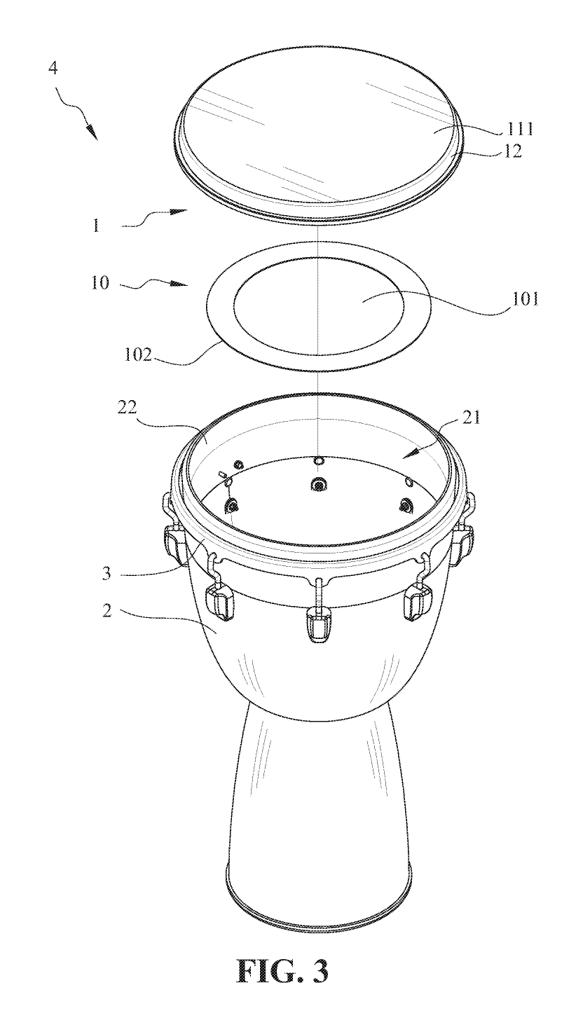

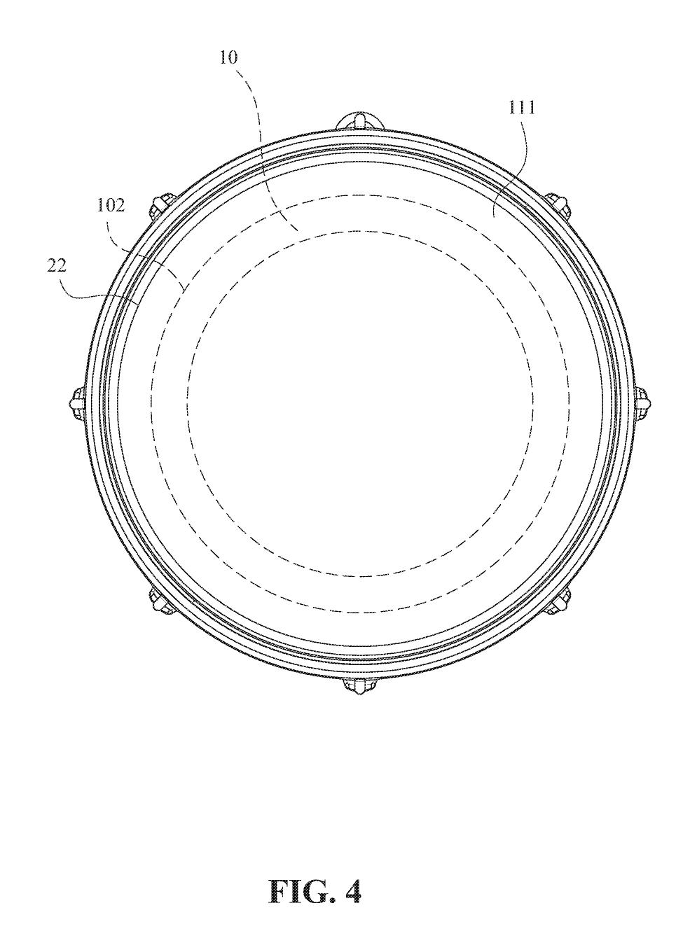

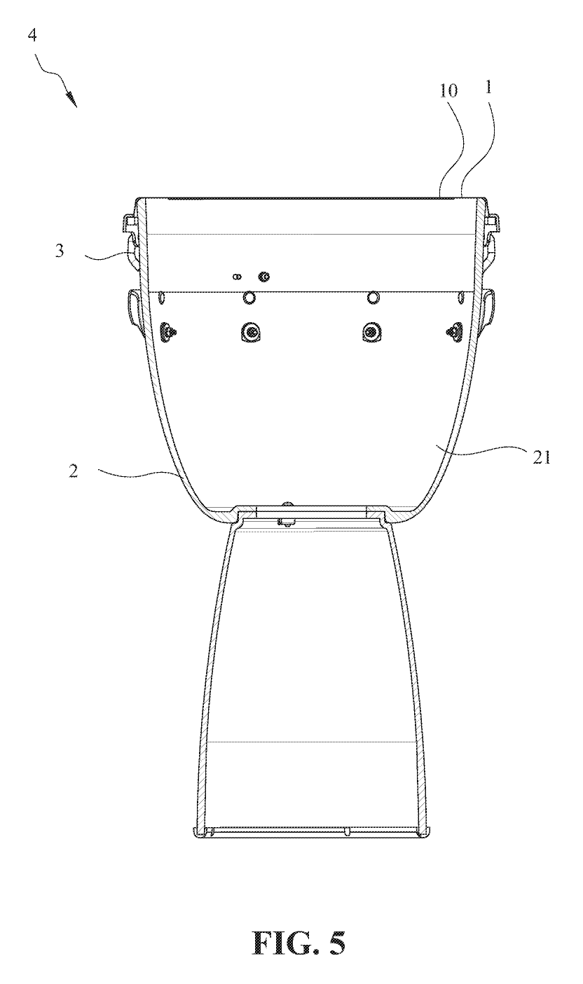

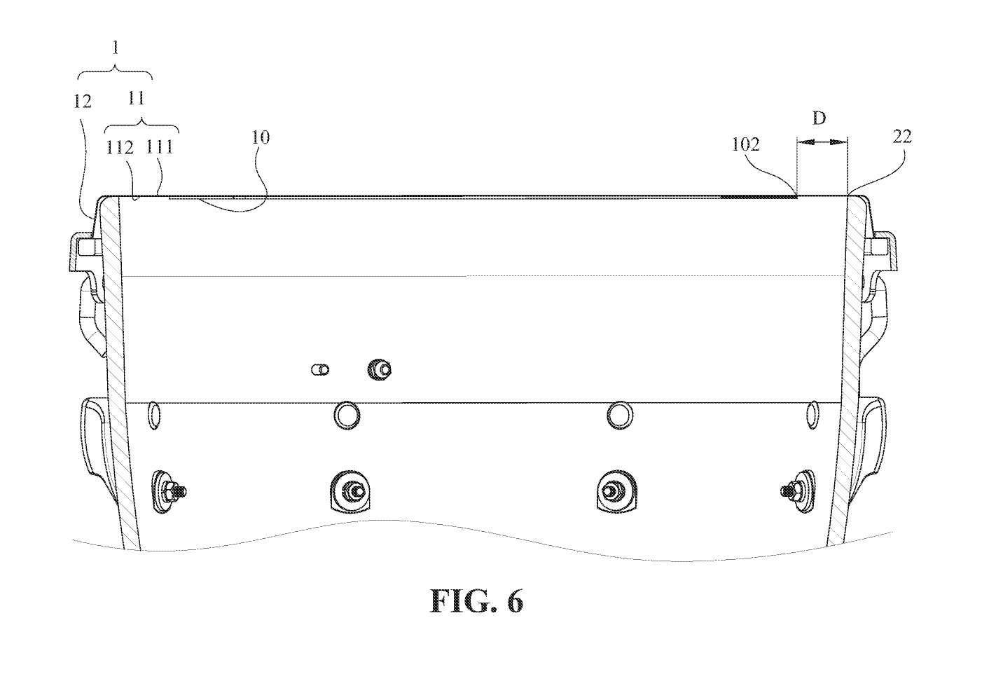

Referring to FIGS. 2 to 6, wherein FIG. 2 is a perspective view of a drum, which is constituted by a drum shell, a drum head, a hoop and a tuning ring of the present invention; FIG. 3 is an exploded and perspective view of the drum together with the tuning ring of the present invention; FIG. 4 is a top view of the drum together with the tuning ring of the present invention; FIG. 5 is a cross sectional view of the drum together with the tuning ring of the present invention; and FIG. 6 is a fragmentary cross sectional view of the drum together with the tuning ring of the present invention. The tuning ring of the present invention is used for adjusting a sound timbre of a drum head, includes a tuning ring body 10 adapted to be provided beneath a bottom surface 112 of the striking portion 11 of the drum head 1 in the drum 4 and having an opening 101.

To be more specific, the drum 4 generally includes a drum shell 2, a drum head 1 mounted on a top end of the drum shell 2 and having a striking portion 11, where a drummer beats thereon, and a hoop or rim 3 sleeved around the drum head 1 in order to secure the same on the drum shell 2. The drum 4 may be a jazz drum, an African drum, a conga drum, a marching drum or a mambo drum. The drum shell 2 generally defines a hollow chamber 21 while the drum head 1 includes a striking portion 11 and an outer ring portion 12. The striking portion 11 has a top surface 111, the bottom surface 112 and an outer peripheral portion confining the bottom surface 112 and abutting against the top end of the drum shell 2 while the outer ring portion 12 is fixed to an outer surface of the drum shell 2 to extend downward from the striking portion 11 for enclosing the hollow chamber 21 entirely.

Once the tuning ring body 10 of the tuning ring of the present invention is implemented in a drum, the tuning ring body 10 is disposed at a position, where the drum stick cannot directly hit on the same, but the tuning ring body 10 can adjust the sound timbre of a drum head, the overall thickness of the tuning ring body combined with the drum head 1, thereby changing the characteristic of the original sound timbre of the drum head and reducing the unstable sound timbre, the uncertainty of pitch overtone, shortening the duration of the waveform, and hence the sound timbre is clear and is concentrated to be a thicker sound timbre and optimizing the tuned sound timbre of the drum head. If the tuning ring body 10 of the present invention is applied to the drum head, which has been stretched to a finished state, the tuned sound timbre does not change, and achieving the abovementioned optimal quality of the tuned sound timbre. The abovementioned advantages are obvious when the tuning ring body 10 has a thickness less than 1 mm. It is to note that the advantages are more obvious when the thickness ranges 0.1-0.3 mm, the adjusting of the sound timbre is obvious in addition to reducing the material for fabrication of the tuning ring body.

In one embodiment of the present invention, the tuning ring body 10 defines an axis coaxial with the opening 101 and further has a surface area equivalent to 20-40% surface area of the striking portion 11 of the drum head 1 such that the beatings of the drum stick at an interior and an exterior of the striking portion 11 generate the sound timbre of different thickness of feelings. By minimizing the surface area of the tuning ring body 10, the manufacturing cost can be cut down, especially when the tuning ring body 10 has the surface area equivalent to 25-35% surface area of the striking portion 11 of the drum head 1, the abovementioned advantages are more obvious.

In one embodiment of the present invention, the tuning ring body 10 is cylindrical while the opening 101 is a circular hole. As best shown in FIGS. 3 and 4, the tuning ring body 10 has a plurality of sonic conduction circles with equal width to provide the uniform sound conduction, thereby providing optimized tuned sound.

In another embodiment of the present invention, the tuning ring body 10 is polygonal or irregular in configuration. If the tuning ring body 10 is polygonal, the opening 101 is defined by polygonal side walls. If the tuning ring body 10 is irregular in configuration, so does the opening 101. However, in all these configurations, the tuning ring body 10 having the more similar to cylindrical shape with the plurality of sonic conduction circles with the more similar width provides the more uniform sonic conduction. In reverse, the tuning ring body 10 having the less similar to the cylindrical shape with the plurality of sonic conduction circles the less similar width provides the less uniform sonic conduction.

In one embodiment of the present invention, the drum shell 2 has a top part and a peripheral portion confining the bottom surface of the striking portion of the drum head 1 for abutting against the top part of the drum shell 2. The drum shell 2 further has an inner peripheral portion 22 confining the top part and spaced apart from an outer peripheral portion 102 of the tuning ring body 10 by a distance D1 10-40 mm (see FIG. 6), thereby avoiding the interference between the two and sustaining the tuned sound timbre. It is noted that when the spaced apart distance ranges between 15-30 mm, the abovementioned advantages are more obvious.

In one embodiment of the present invention, the tuning ring body 10 is fabricated from plastic film and/or membrane or paper. However, the scope thereof should not be limited only to the disclosed ones, many other substances should be included and different plastic materials provide the different characteristics of films. The plastic materials preferably include PVC (polyvinyl chloride), PET or PETE (polyethylene terephthalate), wherein, the tuning ring body 10 fabricated from these materials provides the better advantages and the materials are easily obtainable too.

In one embodiment of the present invention, the tuning ring body 10 has a top end 111 formed with an adhesive layer (not visible) via which the tuning ring body 10 is adhesively attached to the bottom surface 112 of the striking portion 11 of the drum head 1. An experimental test reveals that the adhesive layer with more than a thickness of 0.05 mm may lower the tuning quality of the tuning ring body 10. The reason resides in that the softness of the adhesive layer may absorb too much of the waveform of sonic conduction. Therefore, maintaining the thickness of the adhesive layer ranging 0.01-0.05 mm provides the tuning features or else may result in adverse advantages. In other embodiments, other available methods can be implemented in order to fix the tuning ring body 10 underneath the bottom surface 112 of the striking portion 11 of the drum head 1.

In one embodiment of the present invention, the tuning ring body 10 is a single piece. In other embodiment, several pieces of the tuning ring bodies 10 constitute one tuning ring body and are provided beneath the bottom surface 112 of the striking portion 11 of the drum head 1 in an overlapping manner. The number of the tuning ring body 10 may affect the overall combined thickness of the drum head 1, but after an experimental test, it is found that the tuning effect is not more prominent regardless of the tuning ring body 10 being plural or singular. In other words, the tuned sound timbre provided from a single piece of tuning ring body and the tuned sound timbre provided from several pieces of tuning ring bodies combined is equivalent relative to each other, but fabrication of plurality of tuning ring bodies may cost more than fabrication a single tuning ring body 10, therefore a single piece is preferred to rather than several pieces herein.

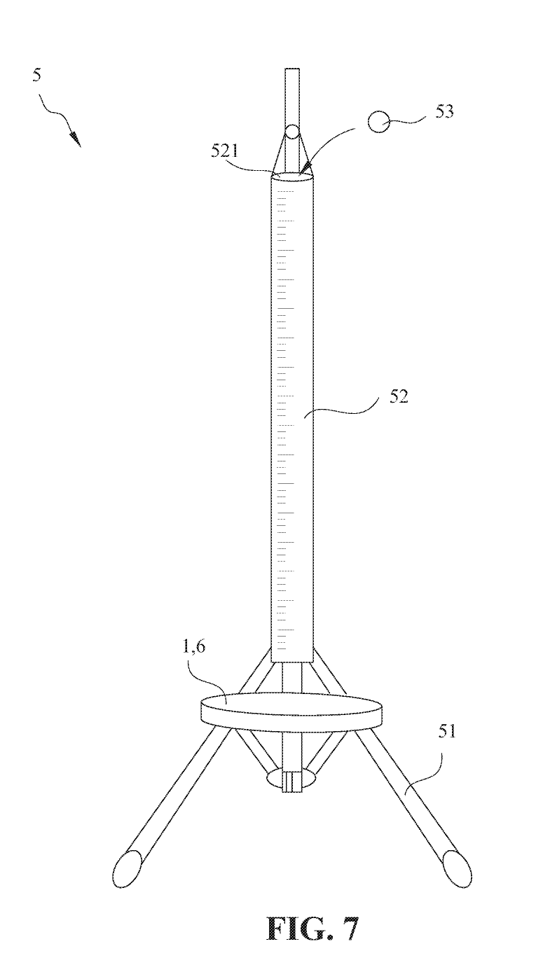

FIG. 7 shows a drum head beating test device 5 for conducting test adjustment of a sound timbre of a conventional drum head and a drum head provided with the tuning ring of the present invention. As illustrated, the drum head beating test device 5 includes a support stand 51, a hollow acrylic tube 52 and a glass ball 53, wherein the acrylic tube 52 is mounted erectly on the support stand 51; the conventional drum head 6 or a combination of a drum head 1 and the tuning ring body of the present invention is mounted horizontally on the support stand 51 below the acrylic tube 52 such that the top surface 111 of the striking portion 11 of the drum head 1 is spaced apart from a shooting mouth 521 of the acrylic tube 52 by 1.2 meters. The operation steps include the following:

First of all, the glass ball 53 is thrown into the acrylic tube 52 via the shooting mouth 521 so as to hit and measure the force of the glass ball falling onto the top surface 111 of the striking portion 11 of the drum head 1;

Referring to the following table 1, wherein Table 1 shows the impact data of the glass ball falling from a height of 1.2 meter:

TABLE 1

| | | | | | | Safety Factors | | |
|---|---|---|---|---|---|---|---|---|
| | | Weight | Weight | Impact | | (Impact) | | |
| Item | Diameter | (gm) | (Kg) | Newton | Kg | 1.5 | 2.0 | 3.0 |
| Glass | 42.3 | 99 | 0.099 | 9.602 | 0.98 | 1.47 | 1.96 | 2.94 |
| ball | | | | | | | | |

Remarks: g = 9.8 m/s²; h = 1.2 m; t = 0.05 s

According to abovementioned impact and weight calculation equation, the impact force 0.98 Kg (equivalent to 9.6 Newton) is caused by the fall of the glass ball 53 of 99 gms. This force may have the appropriate strength and does not produce broken distortion phenomenon of sound. The signal is enough strong to measure and in accordance with the experience to determine the general sound similar to the general performance of the play.

Moreover, a notebook computer can be placed within a conventional drum head 6 and/or a combination of a drum head 1 provided with the tuning ring body of the present invention by spacing apart 50 cm to collect the tuned sound timbre and is tested by a software Goldwave V6.3 version and conduct the analysis by using the waveform with the same sound pressure (dB) value.

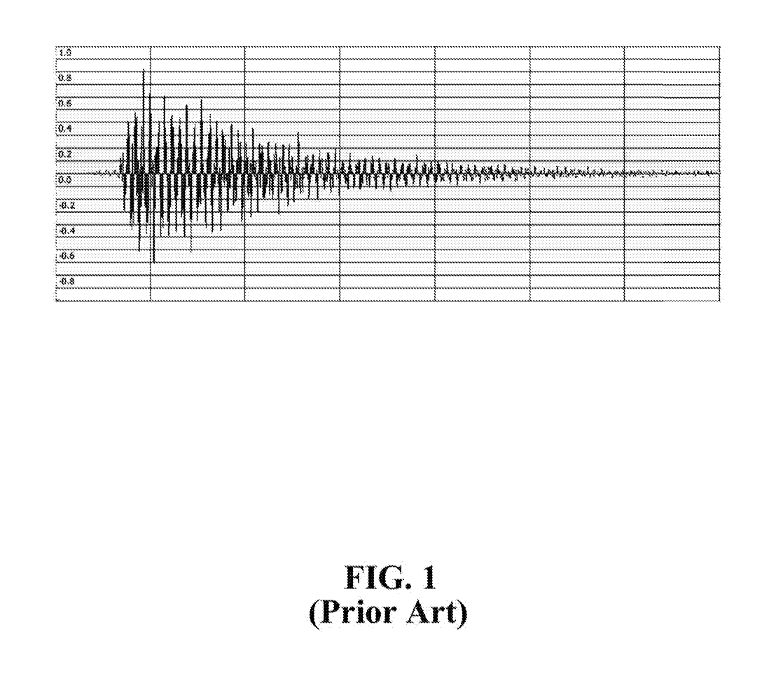

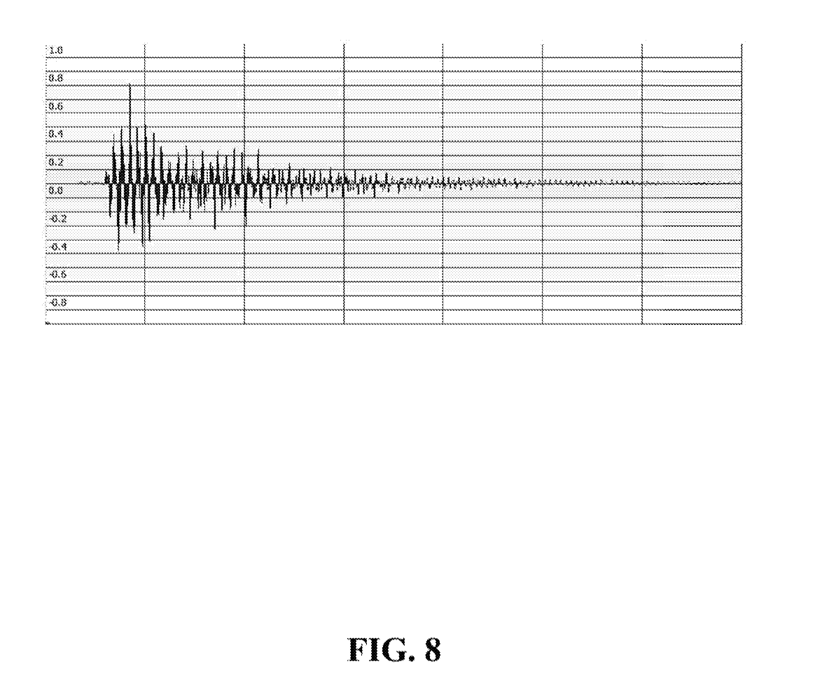

The conventional drum head 6 and/or a combination of a drum head 1 provided with the tuning ring body of the present invention are tested by the abovementioned drum head beating test device by using the same strength, the same distance and under the same conditions to collect the tuned sound timbre, the results of which are shown in FIGS. 1, 8 and 9 respectively.

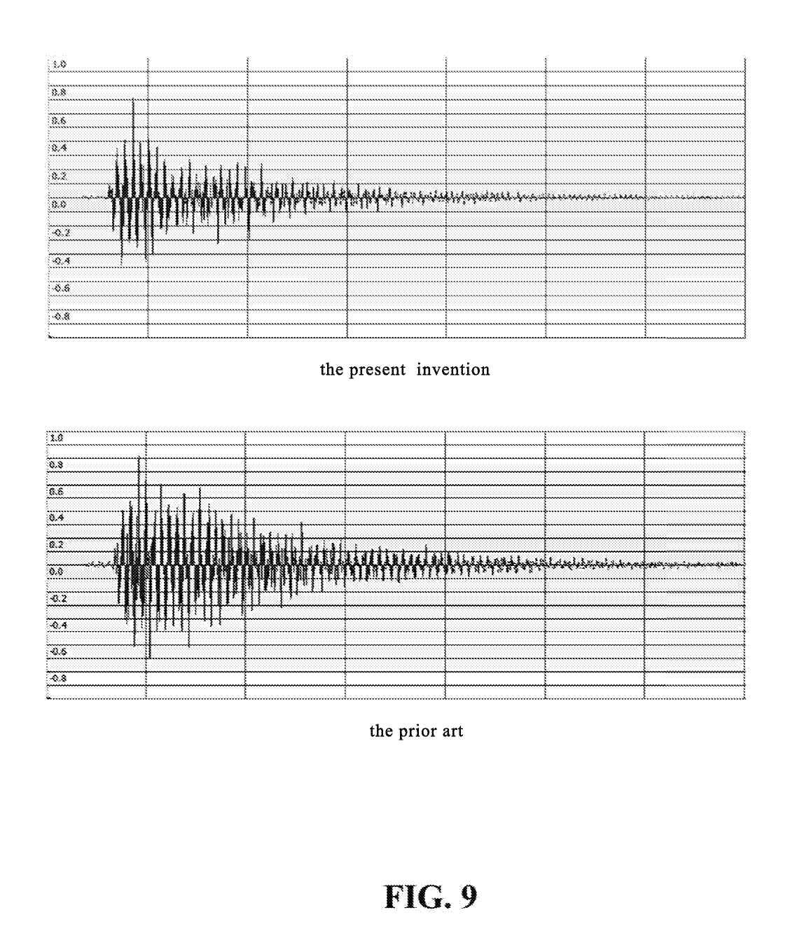

As illustrated in FIG. 9, the overall waveform of the sound waves generated by the conventional drums 6 is more complicated, which indicates that the uncertain fluttering overtone and the overall waveform is longer, which means that the sound is more unstable, more uncertain in the fluttering process and the ending sound seems longer. In the case of continuous beating of the conventional drum head, the latter may generate more overtones and overlapping sound, the sound thickness and intensity of the feeling is significantly weak.

In reverse, the overall waveform of the sound waves generated by the combination of the drum head 1 provided with the tuning ring body of the present invention is rather clear, the uncertain fluttering overtone being lesser and the overall duration of the waveform being shorter, which means that the effective sound is short and is concentrated to be a thicker sound timbre. These features are caused due to increase of the overall thickness of the combination of the drum head 1 provided with the tuning ring body of the present invention.

From the above comparison, it is obvious that the tuning ring of the present invention for adjusting the sound timbre of a drum head provides a remarkable effect on the improvement of the sound timbre of the drum 1, and a cleaner, more concise and thicker sound quality.

Although the present invention has been described with reference to the preferred embodiment thereof, it is apparent to those skilled in the art that a variety of modifications and changes may be made without departing from the scope of the present invention which is intended to be defined by the appended claims.

1. A tuning ring for adjusting a sound timbre of a drum head, wherein the drum head has a striking portion, where a drummer beats thereon, the tuning ring comprising:
a tuning ring body adapted to be provided beneath a bottom surface of the striking portion of the drum head and having an opening;
wherein, said tuning ring body is cylindrical, defines an axis coaxial with said opening and is fabricated from plastic film;
wherein, material of said plastic film is selected from a group consisting of PVC (polyvinyl chloride), PET or PETE (polyethylene terephthalate).

2. The tuning ring according to claim 1, wherein said tuning ring body has a surface area equivalent to 20-40% surface area of the striking portion of the drum head.

3. The tuning ring according to claim 2, wherein said tuning ring body has a surface area equivalent to 25-35% surface area of the striking portion of the drum head.

4. (canceled)

5. The tuning ring according to claim 1, wherein said tuning ring body has a top end formed with an adhesive layer via which said tuning ring body is adhesively attached to the bottom surface of the striking portion of the drum head.

6. The tuning ring according to claim 5, wherein said adhesive layer has a thickness of 0.01-0.05 mm.

7. The tuning ring according to claim 1, wherein said tuning ring body has a thickness less than 1 mm.

8. The tuning ring according to claim 1, wherein a drum shell has a top part and a peripheral portion, said bottom surface of the striking portion of the drum head abuts against the top part of the drum shell, said drum shell further having an inner peripheral portion confining said top part and spaced apart from an outer peripheral portion of said tuning ring body by a distance 10-40 mm.

9. (canceled)

10. The tuning ring according to claim 1, comprising a plurality of said tuning ring bodies provided beneath the bottom surface of the striking portion of the drum head in an overlapping manner.
